(19) United States
(12) Patent Application Publication
(10) Pub. No.: US 2022/0205462 A1
(43) Pub. Date: Jun. 30, 2022

(54) ENERGY EFFICIENCY INCREASING SYSTEM FOR HYDRAULIC DEVICES

(71) Applicant: Luis OLVERA DÍAZ, Santa Rosa Jáuregui (MX)

(72) Inventor: Luis OLVERA DÍAZ, Santa Rosa Jáuregui (MX)

(21) Appl. No.: 17/430,313

(22) PCT Filed: Feb. 14, 2019
(86) PCT No.: PCT/MX2019/000013

§ 371 Date: Aug. 11, 2021

(51) Int. Cl. F15B 1/04; F15B 15/18; F15B 13/02

(52) U.S. Cl. CPC F15B 1/04; F15B 13/02; F15B 15/18

(57) ABSTRACT

The invention relates to a system that intensifies hydraulic pressure, which comprises a main actuation subsystem and a direction-change sub-system. The main actuation subsystem comprises: a motor; a pump; a first piston with a plunger that moves linearly; a travel-limit sensor and a two-way valve at each end of the piston; a pressure control valve connected to the two-way valves; a second piston similar in always to the first and connected to the pressure control valve; a hydraulic motor connected to the two-way valves of the second piston to generate work; and a fluid-cooling means. The direction-change subsystem comprises a secondary motor, a second pump, a pressure accumulator and a pair of solenoid valves for the parallel and independent operation of the two-way valves of the main actuation subsystem.

### CROSS-REFERENCE TO RELATED APPLICATION

This application is a national stage application, filed under 35 U.S.C. § 371, of International Patent Application No. PCT/MX2019/000013, filed on Feb. 14, 2019, which is incorporated by reference herein in its entirety.

### TECHNICAL FIELD

This invention relates to the field of hydraulic pressure intensifier systems. Particularly, this invention relates to a hydraulic pressure generation and transmission system, which allows to efficiently increase the energy from angular displacement systems for its later use in other systems which require to do some work.

### BACKGROUND OF THE INVENTION

Unlike a solid, a force applied to a confined liquid is transmitted equally through the liquid in the form of pressure, whether the application of the force comes from any other energy system or any combination of forces. Just as the liquid can take the shape of any container, the pressure exerted is also transmitted irrespective of the shape of the container.

A hydraulic pressure intensifier is a mechanical device that is used to increase the pressure of a liquid, using the largest amount of liquid at low pressure. These types of devices are useful in situations where hydraulic machines, such as presses, engines, injectors, generators, etc., require liquids at high pressure which are not normally available directly from the pressure from a pump. This pressure can be provided by introducing an intensifier between the pump and the machine.

Hydraulic pressure intensifiers, in their most basic conception, are mechanically built by connecting two plungers, each operating in a separate cylinder, usually of different diameters. This concept is developed from Pascal's law for incompressible fluids. If the diameters of the plungers are different, the hydraulic pressure in each cylinder will vary with the area ratio of the plungers, and the smaller plunger will result in a higher pressure intensity than the higher pressure intensity of the plunger.

Hydraulic pressure intensifiers are mainly classified as: single-acting or double-acting intensifiers. Single-acting intensifiers flow only during the plunger's forward movement within the cylinder.

They typically use a servo valve to control the displacement of the plunger. This type of intensifier is used in applications where the injected volume or pressure is administered in real time as in the filling of UHP tanks (hydroforming, isostatic pressing), in test benches for UHP components (diesel injection components, valves), among others. The double-acting intensifiers flow during the forward and backward motions of the plungers. Normally they make use of check valves and pressure accumulators, this type of intensifier is used in applications that require a constant flow in continuous works such as water jet cutters or electrical generators. Most of these systems operate with chemical energy sources derived from fossil fuels, which have a negative impact on the environment and are not renewable.

These two types of hydraulic intensifiers have evolved to cover various applications and requirements within the industry, mainly through the shape, construction and assembly of the hydraulic intensifier body.

These modifications have given rise to various types of intensifiers such as: Tie-Rod type (With tie red or coupling bar), threaded construction, bolted construction, single-piece welded cylinders and varied or mixed construction.

One of the main problems that current hydraulic intensifiers present is that they do not allow adding up the hydraulic pressure in the same line or pipe, to considerably increase their work capacity to be delivered to other systems. Likewise, current systems present drops in volume and pressure throughout the system, mainly in each directional change of the plungers, both for single-acting and double-acting intensifiers.

Another problem of current pressure intensifying systems is the increase in temperature of the liquids when subjected to high pressure, which can cause a change in the behavior of the liquid and therefore generate problems such as cavitation, blocking and/or filtering of the fluid to the outside. Likewise, current pressure intensifier systems do not allow operating at high frequencies (close to 60 Hz) continuously, which is ideal for the generation of electrical energy, and which would allow not to use accessory systems for the optimal generation of electrical energy such as: energy rectifiers and inverters. Regarding the systems for the transformation and cogeneration of energy (such as electrical motors), most of them allow up to 90% efficiency, however, there are dynamic systems with efficiencies ranging from 30% to 70%, including conventional plants to produce electrical energy whose efficiency does not exceed 65%.

In accordance with the foregoing, in the state of the at there is the parent document ES2009006A6, which describes a pressure generator, which is constituted by two pairs of hydraulic cylinders, each pair's cylinders are linked at their ends by means of directional cameras closed with end caps, each camera presenting in its interior a spool that moves due to the effect of pressure that comes from directional valves activated by solenoids that are activated by limit switches presented by the low-pressure cylinders, in such a way that a high pressure of the liquid is generated which reaches a connector and from which it leaves towards the corresponding hydraulic motor. However, this pressure generator delivered a conversion efficiency of up to 80% energy, since it uses a displacement gear pump and does not use a control system to control the directional changes of the plungers.

There is also document WO9202713A1, in which a pressure generator that allows multiplying the discharge pressure through the use of sealed cameras containing rodless pistons that act on the fluid that works as a force transmitter and concentrates the force in the tapered covers. At each end of the piston. Due to the narrowing of the covers, the force is directed towards the directional valves that are housed at the ends of the piston and distribute the pressure in an orderly manner through the fluid conductors towards the hydraulic motor. However, this invention does not use logic control systems nor does it have liquid cooling systems, likewise this system generally has a general efficiency of 90% of energy conversion.

There is also the document WO9202713A1, which describes a hydraulic pressure intensifier coupled to a high pressure hydraulic pump, which is actuated by a hydraulic alternative actuation apparatus in which a reciprocating low-pressure actuation piston and a control valve system direct the fluid from a source of fluid under pressure alternately to opposite sides of the low-pressure piston. The control valve system comprises separate valves, one of which is adapted to be actuated by a pressurized fluid and is arranged to reverse the action of the piston. Another valve is a pilot valve arranged to control the action of the switch valve. The action of the switch valve is stable and occurs over a relatively short period of tune, while the action of the pilot valve occurs at the speed of the movement of the low pressure piston. A characteristic of the low pressure actuation apparatus is the absence of dynamic seals in the switch valve and in the pilot valve. However, this system lacks fluid cooling systems and does not specify the capacity for efficiencies in the transmission of hydrostatic work to other systems, likewise, it does not indicate whether it could work in any way in coordination (serial or parallel) with other similar or equal pressure intensifiers, nor does it specify whether it is possible to accumulate in a same line the pressure accumulated from the use of previous hydraulic intensifiers.

In the same way, there is also document US2005133090, which refers to a hydraulic pressure intensifier that allows energy recovery: composed of semi-permeable membranes; of positive displacement with no valves and pumps or separate pump sets that move an unequal volume of fluid at a stable rate within a shared circuit. The device works without the need for valves, cams, sliding fluid control pans, switches, timers, regulators, sensors, electrical or electronic circuits or any other means of flow control, restriction and/or distribution that acts in a similar way. It can be actuated by a variety of prime movers, such as rotating or ratchet rods, wind turbines, water wheels, the trackers of the waves and the engines, as well as by a relatively low pressure fluid feed provided by incorporated or external feed pumps or by any other suitable low pressure fluid feed means. However, in this system, it is not indicated whether it could work in any way in coordination (serial or parallel) with other similar or equal pressure intensifiers nor does it specify whether it is possible to accumulate in a same line the pressure accumulated from the use of previous hydraulic intensifiers, the flow control and therefore the permanence of the pressure drops in the system are evident.

Therefore, in the state of the art, there is not yet a hydraulic pressure intensifier system, which allows to efficiently take advantage of the energy coming from angular displacement systems for its later use in other systems which require some work to be done up to 100% efficiency, which allows adding up the hydraulic pressure in the same line or pipe, does not present drops in volume and pressure throughout the system, allows to control the increase in temperature of the fluids when they are subjected to high pressure within the system, operates at high frequencies (close to 60 Hz) continuously with the purpose of being used in applications such as electric energy generation and other applications which require efficient transmission of energy and work.

### SUMMARY OF THE INVENTION

It is an object of this invention to provide a hydraulic pressure intensifier system, which allows to efficiently increase the energy coming from angular displacement systems up to ‘100%.

Another object of this invention is to provide a hydraulic pressure intensifier system, which allows adding up the hydraulic pressure generated in the same line or pipe.

A further object of this invention is to provide a hydraulic pressure intensifier system, which uses hydraulic pressure generators in a series configuration.

Another object of this invention is to provide a hydraulic pressure intensifier system, which allows to control the increase in temperature of fluids when subjected to high pressure within the system.

Another object of this invention is to provide a hydraulic pressure intensifier system which operates at high frequencies continuously for the purpose of being used in applications such as electrical energy generation.

Yet another object of this invention is to provide a hydraulic pressure intensifier system, which can be operated through automatic control systems.

These and other objects are achieved through a hydraulic pressure intensifier system, which is mainly composed of: a main actuation subsystem; and a directional change subsystem: wherein said main actuation subsystem comprises an angular-power-generating main motor, a pump connected to said motor and to a fluid reservoir, which sucks said fluid and fluidly displaces it: a means for generating and increasing pressure to provide fluid at a first pressure which comprises, a first piston which inside it has: a plunger that moves linearly from an initial position to a final position and a travel limit sensor at each end of said piston; a 2-way valve at each outer end of said piston, which restricts or allows the passage of fluid to the interior or exterior thereof a pressure control valve, fluidly connected to said 2-way valves, which has the function of accumulating and increasing said first pressure to a predetermined parameter to obtain a second pressure; a second piston fluidly connected to the pressure control valve, to receive the fluid with said second pressure, said second piston comprises inside: a plunger that moves linearly from an initial position to a final position and a travel limit sensor at each end of said piston; A 2-way valve at each outer end of said second piston, which restricts or allows the passage of fluid to the interior or exterior thereof, wherein said second piston increases the second pressure of the fluid to obtain a third pressure twice as high than the first pressure: a hydraulic motor, fluidly connected to said 2-way valves, which receives the fluid with the third pressure for its later use in other systems which require some work: a fluid cooling means, which cools the fluid coming from the hydraulic motor to send it to the fluid reservoir; and wherein said directional change subsystem comprises an angular-power-generating secondary motor, a second pump connected to said secondary motor and to said fluid reservoir, which sucks said fluid and fluidly displaces it; a pressure accumulator that receives the fluid displaced by the pump and that has the function of increasing the pressure in said fluid; a pair of electrovalves fluidly connected to said pressure accumulator to receive and direct the fluid with increased pressure towards the first and second pistons to return the plungers to their initial position to start a new work cycle, wherein said directional change subsystem operates parallel to and independently from said main actuation subsystems to end a complete cycle and repeat it indefinitely while the system is in operation.

Additional features and advantages of the invention should be more clearly understood by the detailed description of its preferred embodiment, given by way of a non-limiting example with reference to the accompanying drawings, in which:

### BRIEF DESCRIPTION OF THE DRAWINGS

FIG. 1 is a schematic representation of an embodiment of a hydraulic pressure intensifier system in accordance with the present invention.

FIG. 2 is a schematic representation of an embodiment of a one-way drag coupling of a hydraulic pressure intensifier system in accordance with the present invention.

FIG. 3 is a schematic representation of the plungers of an embodiment of a hydraulic pressure intensifier system in accordance with the present invention.

FIG. 4 is a schematic representation of a second embodiment of a hydraulic pressure intensifier system in accordance with the present invention.

FIG. 5 is a schematic representation of a third embodiment of a hydraulic pressure intensifier system in accordance with the present invention.

FIG. 6 is a schematic representation of a fourth embodiment of a hydraulic pressure intensifier system in accordance with the present invention.

### DETAILED DESCRIPTION AND BEST MODE OF IMPLEMENTATION

The following detailed description of the embodiments of the invention refers to the attached figures. Although the description includes exemplary embodiments, other embodiments or changes to the described ones are also possible without departing from the intention and scope of the invention. Those skilled in the art should appreciate that the configurations disclosed in the following embodiments represent configurations proposed by the inventors for the operation of the invention in practice. However, those skilled in the art should appreciate that many changes can be made in the specific embodiments that are disclosed herein obtaining a result that does not depart from the spirit and scope of the invention.

It is important to mention that being a hydraulic system, it must be fully saturated with liquid fluid, before starting, it is worth mentioning that the system described uses an electrical motor as the main source of energy, in addition to an electrical motor of less ability to operate the directional changes system, the electrical motors are electrically powered by a source external to the system.

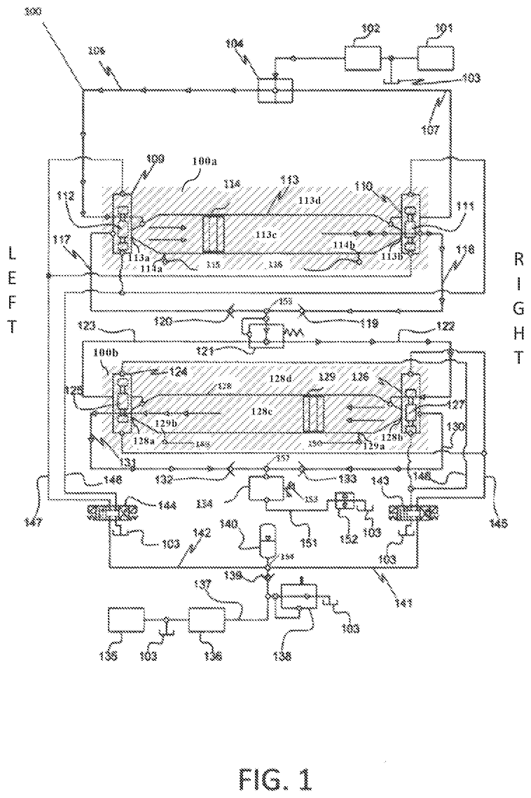

With reference to FIGS. 1 to 3, the preferred embodiment of the hydraulic pressure intensifier system is generally shown in (100), the description of which is as follows, when the system is started by electric starters, the motors, the main one being an angular-power-generating Main Motor (101) and the angular-power-generating Secondary Motor (135) start at the same time. Both motors transform the electrical energy they receive into angular mechanical energy, where the Main Motor (101) moves the first pump (102) and the Secondary Motor (135) moves the second pump (136) and these transform the angular mechanical energy into hydraulic energy” When both pumps operate, they begin to suck liquid fluid located in the fluid reservoir (103), in which sufficient reserve liquid fluid is stored in addition to the fluid used to fully saturate both the main system and the directional changes system, which operates in a parallel and independent way from the main system.

Firstly, the way in which the directional change subsystem operates and how it is more efficient working independently from the main system will be described. When the fluid is sucked in by the second pump (136) it connects with the line (137) that leads to the check valve (139) which allows it to pass, but does not allow it to return, after passing the check valve (139) the fluid is conducted to the connector (154) from which lines (141) and (142) are connected and these, in turn, are connected to a pair of electrovalves, the first electrovalve (143) and the second electrovalve (144).

Said electrovalves operate with electrical energy from the electrical source that feeds the Main Motor (101) and the Secondary Motor (135), the first and second electrovalves (143) and (144) have their centers blocked, therefore the fluid cannot continue beyond these so, the fluid is conducted to the pressure accumulator (140) whose function is to store the fluid and press it to a previously calibrated pressure to make use of this volume pressed in each directional change of the first plunger (114) and the second plunger (129). When the pressure accumulator (140) is saturated with fluid to its full capacity and the calibration pressure is exceeded, the relief valve (138) opens and discharges excess to the fluid reservoir (103).

Now with reference to the main system, when the first pump (102) is operated and sucks the fluid located in the fluid reservoir (103), the fluid is conducted to the connector (104) from which the lines (106) and (107) are derived, which connect with the first and second 2-way valves (109) and (110), respectively located contiguous to the left end (113a) and right end (113b) of the first piston (113). Note that in the second 2-way valve (110) the line (107) is blocked by the spool (111) and the main outlet orifice of the first piston (113) connecting to the line (118), at the same time, in the first 2-way valve (109) the spool (112) unblocks the line (106) allowing the fluid from the first pump (102) to pass to be deposited inside the first piston (113), on its left side. The first piston (113) has an interior (113c), inside of it, while everything outside of it is considered the exterior (113d) of the first piston (113). With this action, the first plunger (114) will begin moving towards the right end of the first piston (113) and at the same time moving to fluid trapped on the right side of the first piston (113) downstream of the first plunger (114). It can be observed that the arrows indicate the direction of the fluid, as well as the line that carries it and the line that has no activity. At the time in which the first plunger (114) displaces the fluid contained in the right side of the first piston (113), the fluid is conducted through the line (118) to the check valve (119), which allows the fluid to pass but does not allow it to return in order to lead it to the pressure control valve (121), note that the line (118) connects with the line (117) through the connector (155), and from there it is connected the pressure control valve (121). It should also be noted that the check valve (120) is located in the line (117), which prevents the fluid displaced by the first plunger (114) from interfering with the line (117) and the elements that connect behind it.

The role of the pressure control valve (121) is to raise the pressure, and it occurs when it resists the free passage of the fluid displaced by the first plunger (114). From the pressure control valve (121), from the area where the pressure increases, the lines (122) and (123) are connected, which connect with the third and fourth 2-way valves (124) and (126), respectively located contiguous to the left end (128a) and right end (128b) of the second piston (128), where in the third 2-way valve (124), spool (125) blocks line (123) preventing the fluid to reach inside the second piston (128), and the main outlet orifice of the second piston (128) remains open to connect with the line (131). The second piston (128) has an interior (128c), inside of it, while everything outside of it is considered the exterior (128d) of the second piston (128)

At the same time in the fourth 2-way valve (126) the spool (127) unblocks the orifice that connects with the line (122) allowing the fluid to pass into the second piston (128) on the right side, and at the same time blocks the main outlet orifice, which connects with the line (130), which forces the second plunger (129) to be displaced to the left side of the second piston (128) and the latter towards the fluid located inside the second piston (128) on the left side. The fluid displaced by the second plunger (129) is conducted by the line (131) to the check valve (132) which allows the fluid to pass but does not allow it to return, so the fluid is conducted to the connector (157) that connects to line (130). Note that in the check valve (133) is located the line (130), which prevents the passage of fluid, preventing it from interfering with the line (130) and the elements that are located behind it, in this way the fluid is conducted to the hydraulic motor (134) which has the function of transforming the hydraulic energy into angular mechanical energy, once this function is concluded, the fluid is conducted by the line (151) to the cooling unit (152) whose function is to cool the fluid. Once cooled, the fluid is returned to the fluid reservoir (103) to be used in a new cycle.

At the ends of each of the first and second pistons (113) and (128), there are sensors to limit the travel or course of said plungers, where the first and second travel limit sensors (115) and (116) are located in the first piston (113), respectively at the first initial position (114a) and the first final position (114b) of the first plunger (114), and the third and fourth travel limit sensors (149) and (150) in the second piston (128), respectively at the second initial position (129a) and the second final position (129b) of the second plunger (129): Said travel limit sensors (115), (116), (149) and (150), operate with electrical energy that comes from a source located within the PLC electronic control. When the first plunger (114) is displaced to the right of the first piston (113) by effect of the fluid deposited on the left side thereof, the first plunger (114) in its advance, also displaces the fluid located on the right side of the first piston (113) conducting it out through the main outlet orifice of the first piston (113) that connects with the line (118) (see the arrows that indicate the direction of the fluid).

When the first plunger (114) is displaced to the right of the first piston (113) to its first final position (114b), the first plunger (114) makes contact with the second travel limit sensor (116) and the latter sends an electrical signal to the PLC electronic directional changes control, which processes and forwards it to the corresponding solenoid, after programming the second 4-way directional electrovalve (144): the energized solenoid causes said valve to connect the centers, thus allowing the pressurized fluid sent by the pressure accumulator (140) to pass through the line (142). Before continuing with the description, it is important to mention that lines (147) and (148) are connected from the second electrovalve (144) and these are connected with the first and second 2-way valves (109) and (110) at the ends corresponding to each one of them, as shown in FIG. 1. Line (147) connects to the 2-way valves, with the first 2-way valve (109) at its upper end, and with the second 2-way valve (110) at its lower end. Line (148) also connects to the first 2-way valve (109) at its lower end and with the second 2-way valve (110) at its upper end.

When the second electrovalve (144) connects its centers and allows the pressurized fluid from the pressure accumulator (140) to pass, the second electrovalve (144) connects the fluid with the line (148) which leads it to the first and second 2-way valves (109) and (110), in the first 2-way (109) a part of the pressurized fluid is applied at its lower end and at the same time in the second 2-way valve (110) another part of the pressurized fluid is applied at its upper end. At the same time, one of the centers of the second electrovalve (144) opens and connects to the line (147) with the fluid reservoir (103), in order to discharge the fluid located inside the first and second 2-way valves, in the (109) at its upper end, after the spool (112) and in the (110) at its lower end, before the spool (111). The pressurized fluid coming from the pressure accumulator (140), by the action of the second electrovalve (144), is applied to the first and second 2-way valves (109) at its lower end and (110) at its tipper end; In addition, the line (147) is freely connected to the reservoir, the spools (111) and (112) will travel freely in an instantaneous way inside the 2-way valves, in the first 2-way valve (109), the spool (112) will move towards its upper end including the fluid located at that end, which will be discharged to the fluid reservoir (103) through the line (147), and at the same time in the second 2-way valve (110) the spool (111) will move towards its lower end, including the fluid located at that end, which will be discharged to the fluid reservoir (103) through the line (147). Once the spools (111) and (112) have been displaced, in the first 2-way valve (109) the spool (112) will block the feeding port that connects with the line (106) and will unblock the main outlet orifice of the first piston (113) that connects to line (117). At the same time in the second 2-way valve (110) the spool (111) will unblock the feeding port that connects with the line (107) and will block the main outlet orifice of the first piston (113) that connects with the line (118), in this way the first plunger (114) will begin to move in the left direction of the first piston (113) to its first initial position (114a) and make contact with the first travel limit sensor (115) and conclude with a complete cycle and repeat indefinitely while the equipment is in operation.

The performance of the second piston (128) as shown in FIG. 1 is described below. The line (118) can be observed with arrows that indicate the direction of the fluid which is directed towards the pressure control valve (121), passing first by the check valve (119): It is also observed that from the pressure control valve (121) the lines (122) and (123) are derived and these are connected with the third and fourth 2-way valves, (124) and (126) respectively, where it is observed that the spool (127) unblocks the feeding port that connects with the line (122), meanwhile the spool (125) of the third 2-way valve (124) blocks the feeding port that connects with the line (123) and unblocks the main outlet orifice of the second piston (128) that connects with line (131). The fluid supplied by the first piston (113) and pressurized by the pressure control valve (121), it is conducted by the line (122) to the inside of the second piston (128) on the right side of the latter, so that the second plunger (129) will move towards the left side of the second piston (128) also displacing the fluid located on the left side of the second piston (128), the displaced fluid is conducted through the line (131) to the check valve (132) which allows it to pass but does not allow it to return, the line (131) continues to lead the fluid to the connector (157) that joins the lines (131) and (130), note that in line (130) the check valve (133) is located, which prevents the fluid conducted by the line (131) from interacting with the line (130) in this way the fluid conducted by the line (131) is applied directly to the hydraulic motor (134) which converts the hydraulic energy into angular mechanical energy. Once this function is carried out, the fluid is conducted by the line (151) to the cooling unit (152) which is a cooling means that will return the fluid to the fluid reservoir (103) at a temperature between 40° C. and 60° C. (degrees centigrade) to be used again in a new cycle.

When the pressurized fluid coming from the first piston (113) is conducted inside the second piston (128) by the line (122), the second plunger (129) moves towards the left side of the second piston (128), dragging the fluid located in that side; When the second plunger (129) moves to second initial position (129a) of the second piston (128), the second plunger (129) makes contact with the third travel limit sensor (149), which sends an electrical signal to the PLC electronic system in charge of controlling directional changes; the PLC processes the signal and forwards it to the first 4-way electrovalve (143) energizing the corresponding solenoid, previously programmed, so that the first electrovalve (143) opens the centers and connects them to the lines (145) and (146) which in addition to connecting with the first electrovalve (143) are connected to the third and fourth 2-way valves (124) and (126), the line (145) is connected to the third 2-way valve (124) at its lower end, and in the fourth 2-way valve (126) it is connected at its tipper end. Line (146) connects to the fourth 2-way valve (126) at its lower end, and the third 2-way valve (124) connects to its upper part, so when the first electrovalve (143) is energized and its centers open and get connected, this allows the pressurized fluid coming from the pressure accumulator (140) to pass, which is conducted by the line (145) to the upper end of the forth 2-way valve (126) and to the lower end of the third 2-way valve (124). At the same time, one of the open centers of the first electrovalve (143) connects the line (146) with the discharge line to the fluid reservoir (103) in order to freely discharge the fluid displaced by the spools (125) and (127) when both are displaced, at the same time, by the pressurized fluid coming from the pressure accumulator (140) and conducted by the line (145), so the spools will travel freely and in an instant way. The spool (125) moves towards the upper end of the third 2-way valve (124) opening the feeding port and connecting the line (123) and blocking the main outlet orifice of the second piston (128) that connects with the line (131). At the same time the spool (127) travels towards the lower end of the fourth 2-way valve (126), covering the feeding port that connects with the line (122) and unblocks the main outlet orifice of the second piston (128), which connects with the line (130): When the second plunger (129) moves to its end on the left side of the second piston (128), the second plunger (129), due to what was described above, will move towards the right end of the second piston (128) dragging the fluid located at the right end of the second piston (128) to be led by line (130) to the check valve (133) that will allow it to pass, but will not allow it to return, so the fluid will continue to be led by line (130) to the connector (157) that connects to line (131): note that the line (131) has the check valve (132) that prevents the fluid conducted by the line (130) from interacting with the line (131) so the fluid conducted by the line (130) will be applied directly to the hydraulic motor (134) and this will convert hydraulic energy into angular mechanical energy. Once the cycle is completed, the fluid is conducted by the line (151) to the cooling unit (152), which will cool the fluid 40° C., and 60° C. (degrees centigrade) and return it to the fluid reservoir (103) to be used in other cycles indefinitely, while the equipment is in operation.

Likewise, it will be evident to those skilled in the art that in a normal work cycle the first plunger (114) and the second plunger (129) can respectively move in the opposite way, that is, the first plunger (114) can move to the left and the second plunger (129) to the right or vice versa: likewise, in additional embodiments of this invention, the first and second plungers (114) and (129) can move towards the same side, without affecting the operation of this invention.

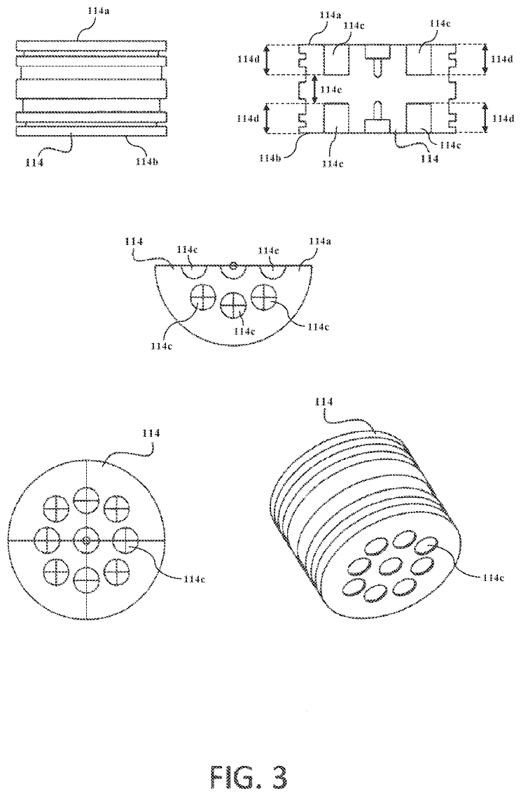

It is important to mention that when the plungers displace from one end to the other in their respective pistons, when they reach their limit, they stop displacing fluid during the time that the directional changes system takes to do it, resulting in a small power drop in the system, so to avoid this drop, modifications have been made to the plungers, as shown in FIG. 3, these consist of making several bores in the two faces of the plunger in charge of carrying out the following functions: on the one hand, to receive the pressurized fluid that displaces the plungers, and on the other, the face that pushes the fluid during its travels, the depth of the bores on both faces must be more or less equal, preventing them from communicating, and a wall of sufficient material must be left to resist high stresses; at the time of making their travels, the plungers, from one end to the other in their respective pistons, in the bores of the face that pushes the fluid, the latter accumulates and pressurizes for two reasons, first, due to the thrust that the plunger receives when the fluid is deposited inside the piston on the opposite side and begins to move the plunger, and the second, due to the opposition that the pressure control valve prevents the fluid from passing freely through it, the fluid passes until the pressure calibration mechanism is overcome by the force that the plunger exerts on the fluid at the moment it begins to move, this being the moment in which, between the plunger and the pressure control valve, pressure is created in the fluid, and in the corresponding line. This pressure and a pail of the displaced fluid is stored in the bores on the face of the plunger that displaces the fluid, when the plunger reaches its limit and stops displacing fluid for an instant, the time it takes for the directional changes system to make the change of direction of the plunger, the pressurised volume inside the bores is discharged at the same time avoiding a drop in volume and pressure in the system that would manifest itself in a momentary power loss. It is important to mention that pressure control valves are strictly necessary, because they are in charge of increasing the outlet pressure in each of the pressure generators used in series, for which the pressure control valve (121) of the first generator (100a) will be calibrated, with the help of a pressure gauge, to a capacity just a minimum below the maximum capacity of the energy source, so that it will always work at its maximum capacity. Should there be a need to attach another pressure generator (100b), its corresponding pressure control valve would be calibrated, with the aid of a pressure gauge, to a capacity just a minimum below the pressure delivered by the pressure generator previous to its corresponding pressure control valve, let us remember that the lines that feed the next pressure generator are connected from the pressure control valves; if it were necessary to add more pressure generators in series, with the exception of the last one that connects to the hydraulic motor, and discharges directly into it all the pressurized fluid displaced by the pressure generators used in series of the system. It is necessary to mention the importance to implement a hydraulic system independent from the main system to make the directional changes of the plungers, and controlled by a PLC electronic unit, for several reasons, first: the second pump (136) is not operated by the Main Motor (101), since if this were the case, it would subtract power from the Main Motor (101) due to the additional transmission that would have to be placed in order to be able to operate it. Second: if the volume necessary to make the directional changes of the plungers was taken from the main system, there would be a momentary power drop at the system output, and although the missing volume is little, it is enough for the hydraulic motor to experience a loss of small power in each directional change of the plungers, and third: the independent hydraulic system is adjusted perfectly so that the PLC electronic system and the limit sensors, control and arrange the directional changes of the plungers.

With respect to the limit sensors, it is important to describe that they are placed on the wall of the piston sleeves, so that the end that penetrates the wall of the sleeves makes contact with the plunger, as it passes alongside it, which allows the electrical signal to be sent to the PLC unit, and the directional change is done. The sensors are also in contact with the fluid, so they must withstand pressures above 5000 psi. As for the power take-off that the system has, it is taken from the shaft of the output of the hydraulic motor (134) of a drag coupling (153), attached to the shaft of the hydraulic motor. The drag coupling (153) has the characteristic of dragging only in one direction, depending on the direction of rotation that the system delivers, either clockwise or counterclockwise, in order to protect the entire system in case of E-stops, for example, if the system is used to move a large alternator, its rotor will be rotating at high speeds, storing a large amount of kinetic energy, so in an E-stop, the inertia could split the shaft of the system's power take-off and affect the hydraulic motor (134). In the event of an E-stop, the safety system of the drag coupling completely disconnects the system from the moving load, allowing it to rotate freely, until its inertia is exhausted in a full stop.

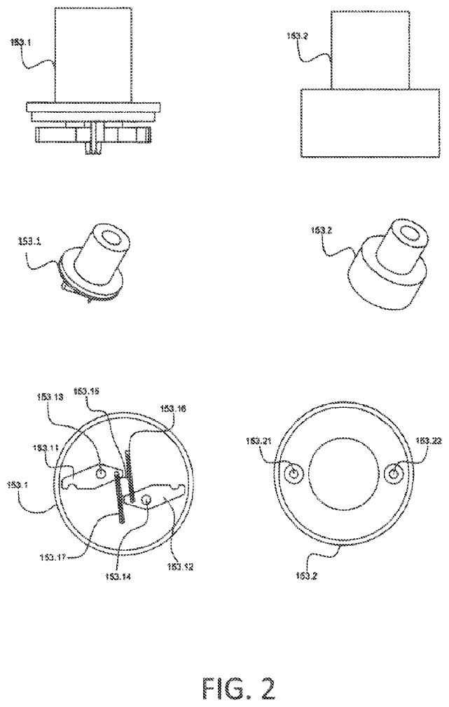

The one-way drag coupling (153), is composed of two main elements of a cylindrical shape as shown in FIG. 2, where the first element (153.1), is attached to the output power take-off of the system by means of a wedge and threaded oppressors, and the second element (153.2), is attached by means of a wedge and threaded oppressors to the input power take-off of the system to be moved; The first element (153.1) has two cams (153.11) and (153.12) and two pivots (153.13) and (153.14) positioned in a normal way so that one of its faces is aligned passing through the center of the main element and the center of the notch, due to their location, makes a lever system in one direction, where the arrow indicates the direction of the drag spin; said lever system has as support points the pivot of each of them (153.13) and (153.14) and in the same way, a central pivot (153.15) that has two extension springs (153.16) and (153.17), which keeps the cam always stuck to the central pivot (153.15); The second element (153.2), has two pivots (153.21) and (153.22) with a diameter equal to the one of the notches of the cams (153.11) and (153.12) of the first element (153.1), located in such a way that, joining the center of their diameters by a line, the latter must pass through the center of the main cylindrical element in addition to being placed equidistant from the center of the main cylindrical element; In the same way, the radius that the centers of the pivots describe is exactly the radius that originates from the central part of the notch of the cams (153.11) and (153.12) of the second element (153.2), in this way, when the main elements are assembled aligned, the pivots (153.21) and (153.22) of the second element (153.2) are assembled with the notches (153.11) and (153.12) of the first element (153.1), this allows to evenly make a drag distributed between the two pivots (153.21) and (153.22) and the two notches (153.11) and (153.12): It must be taken into account that the driving element that drags, can be any of the elements (153.1 or 153.2), as long as the cams are positioned in such a way that they form the levers system, described above, and in the direction to the drag rotation, after starting, in this way the system to be moved will reach its rated speed, and will have stored a large amount of kinetic energy, in such a way that if an E-stop had to be made, the main driving element would stop operating, so the main dragged element would continue to rotate due to inertia; If the main element of the pivots (153.21) and (153.22) is the dragged one, it will continue to rotate, then the main element of the cams will be stopped, at this time the pivots (153.21) and (153.22) in rotation will push the cams (153.11) and (153.12) from the rear, overcoming the force of the springs (153.16) and (153.17) tilting the cams (153.11) and (153.12) allowing the pivots (153.21) and (153.22) to pass freely in each turn completely disconnecting both systems, in order to protect the drive system from a break in the PTO shaft of the hydraulic motor (134) and of breakdowns bigger than its internal elements. Already in full stop, even in movement, the springs place the cams in their normal position leaving them ready for dragging.

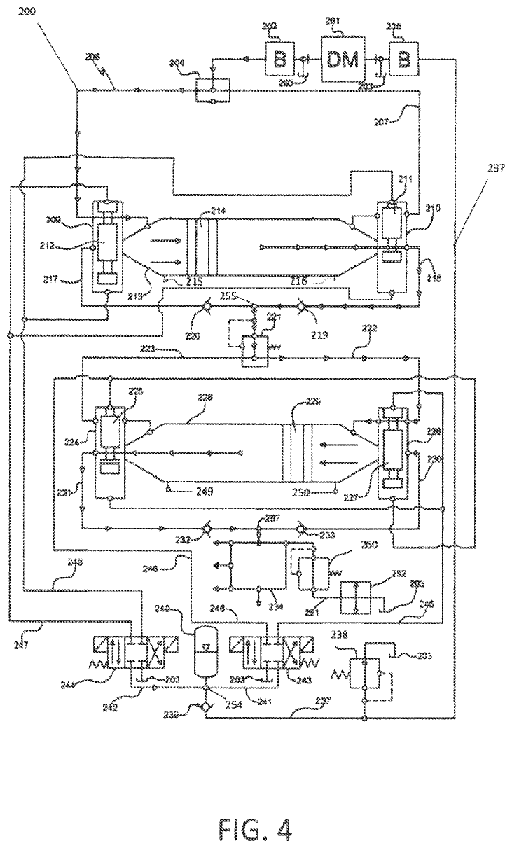

Now with reference to FIG. 4, the second embodiment of the hydraulic pressure intensifier system (200) will be described, where, like the first modality, it must be saturated with liquid fluid in its entirety, it is relevant to mention that the described system uses as its main energy source, a diesel motor which replaces the electrical motor, where the internal combustion motors are powered by the chemical energy derived from the burning of hydrocarbons, also, it is important to mention that control system (PLC, sensors and electrovalves) is powered by batteries that are already included in the machinery described in the title.

When the diesel motor (201) is started, it transforms the chemical energy into angular mechanical energy, which begins to move the pumps (202) and (236) at the same time, and these transform the angular mechanical energy into hydraulic energy. When both pumps operate, they begin to suck liquid fluid located in the reservoir (203), in which sufficient reserve liquid fluid is stored, in addition to the fluid used to fully saturate the entire system, including the directional changes system, which operates parallel to and independently from the main system.

Firstly, the way in which the directional change subsystem operates and how it is more efficient working independently from the main system will be described. When the fluid is sucked by the pump (236) the latter connects with the line (237) that leads it to the check valve (239) which allows it to pass, but does not allow it to return, after passing the check valve (239) the fluid is conducted to the connector (254) from which the lines (241) and (242) are connected and which in turn are connected to the electrovalves (243) and (244). The electrovalves (243) and (244) have their centers blocked, therefore the fluid cannot continue beyond these, so the fluid is conducted to the accumulator (240) which has the function of storing the fluid and pressurizing it to a previously calibrated pressure to make use of this volume pressurized in each directional change of the plungers (214) and (229). When the accumulator (240) is saturated with fluid to its full capacity and the calibration pressure is exceeded, the relief valve (238) opens and discharges the excess to the reservoir (203) through the discharge line (245).

Next, the way in which the main actuation subsystem of said second embodiment operates will be described: When the pump (202) is operated and sucks the fluid located in the reservoir (203), the fluid is conducted to the connector (204) from which the lines (206) and (207) are derived, which connect with the 2-way valves (209) and (210), note that in the valve (210) the line (207) is blocked by the spool (211) and the main outlet orifice of the piston (213) connecting to the line (218) is unblocked, at the same time, in the valve (209) the spool (212) unblocks the line (206) allowing the fluid coming from the pump (202) to be deposited inside the piston (213), on the left side of the latter. With this action, the plunger (214) will begin to move towards the right end of the piston (213) and at the same time displacing the fluid contained in the right side of the piston (213) behind the plunger (214). It can be observed that the arrows indicate the direction of the fluid, as well as the line that carries it and the line that has no activity. At the moment in which the plunger (214) displaces the fluid contained in the right side of the piston (213), the fluid is conducted by the line (218) to the check valve (249) which allows the fluid to pass but does not allow it to return, in order to lead it to the pressure control valve (221), note that the line (218) connects with the line (217) through the connector (255), and from the latter the pressure control valve (221) is connected. Also note that in the line (217) the check valve (220) is located, which prevents the fluid displaced by the plunger (214) from interfering with the line (217) and the elements that connect behind it. The pressure control valve (221) has the function of raising the pressure, and it occurs when it resists the free passage of the fluid displaced by the plunger (214).

From the valve (221), from the area where the pressure increases, the lines (222) and (223) are connected, which connect with the 2-way valves (224) and (226), where in the valve (224) the spool (225) blocks the line (223) preventing the fluid from reaching the interior of the piston (228), and the main outlet orifice of the piston (228) remains open to connect with the line (231). At the same time in the valve (226) the spool (227) unblocks the orifice that connects with the line (222) allowing the fluid to pass to the interior of the piston (228) on the right side, and at the same time blocks the main outlet orifice, which connects with the line (230), which forces the plunger (229) to move towards the left side of the piston (228) and the latter towards the fluid located inside the piston (228) in the left side. The fluid displaced by the plunger (229) is conducted by the line (231) to the check valve (232) which allows the fluid to pass but does not allow it to return, so the fluid is conducted to the connector (257) that connects with line (230). Note that the line (230) is located in the check valve (233), which prevents the passage of the fluid, preventing it from interfering with the line (230) and the elements that are located behind it, in this way the fluid is conducted to the manifold (234) which has the function of connecting the pressure lines to do the work and the typical functions of the machinery to be applied. Once this function is completed, the fluid is conducted by the line (251) to the cooling unit (252), which has the function of cooling the fluid. Once cooled, the fluid is returned to the reservoir to be used in a new cycle.

At the ends of each of the pistons (213) and (228), there are sensors to limit the travel or course of said plungers, where the sensors (215) and (216) are located in the first piston and on the second piston, the sensors (249) and (250): These sensors operate with electrical energy that comes from a source located within the PLC electronic control.

When the plunger (214) is displaced to the right of the piston (213) by the effect of the fluid deposited on its left side, the plunger (214) in its forward movement, also displaces the fluid located on the right side of the piston (213), conducting it to exit through the main outlet orifice of the piston (213) that connects with the line (218) (see the arrows that indicate the direction of the fluid).

When the plunger (214) is moved to the right of the piston (213) to its travel limit, the plunger (214) makes contact with the sensor (216) and the latter sends an electrical signal to the PLC electronic directional changes control, which processes and forwards it to the corresponding solenoid, after programming the directional 4-way electrovalve (244): the energized solenoid causes said valve to connect the centers, thus allowing the pressurized fluid sent by the accumulator (240) to pass through the line (242). Before continuing with the description, it is important to mention that from the electrovalve (244) the lines (247) and (248) are connected and these are connected with the 2-way valves (209) and (210) in the corresponding ends of each one of them. Line (247) connects to the 2-way valves, with valve (209) at its upper end, and with valve (210) at its lower end. Line (248) also connects with the 2-way valves (209) at its lower end and with (210) at its upper end.

When the electrovalve (244) connects its centers and allows the pressurized fluid from the accumulator (240) to pass, the valve (244) connects the fluid with the line (248) which leads it to the 2-way valves (209) and (210), in (209) a part of the pressurized fluid is applied at its lower end and at the same time in the valve (210) another part of the pressurized fluid is applied at its upper end. At the same time, one of the centers of the electrovalve (244) opens and connects to the line (247) with the discharge line to the reservoir, in order to discharge the fluid located inside the 2-way valves, in (209) at its upper end, posterior to the spool (212) and in (210) at its lower end, posterior to the spool (211). When the pressurized fluid coming from the accumulator (240), by action of the electrovalve (244), is applied to the 2-way valves. (209) at its lower end and (210) at its upper end; In addition, when line (247) is freely connected to the reservoir, spools (211) and (212) will instantly travel freely in the interior of the 2-way valves (209), where the spool (212) will move towards its upper end including the fluid located at that end, which will be discharged to the reservoir (203) through the line (247), and at the same time in the valve (210) the spool (211) will move towards its lower end, including the fluid located at that end, which will be discharged to the reservoir (203) through line (247). Once the spools (211) and (212) have been displaced, in the 2-way valve (209) the spool (212) will block the feeding port that connects with the line (206) and will unblock the main outlet orifice of the piston (213) that connects to line (217). At the same time in the 2-way valve (210) the spool (211) will unblock the feeding port that connects with the line (207) and will block the main outlet orifice of the piston (213) that connects with the line (218), in this way the plunger (214) will begin to travel to the left of the piston (213) to its travel limit and make contact with the sensor (215) and conclude with a complete cycle and repeat indefinitely while the equipment is in operation.

Likewise, it will be clear to experts in the field that in a normal work cycle the plungers (214) and (229), can respectively move in the opposite way, that is, the plunger (214) can move to the left and the plunger (229) to the right or vice versa, likewise, in additional embodiments of this invention, the plungers (214) and (229) can move towards the same side, without affecting the functioning of this invention.

The performance of the piston (228) is described below. In it, one can observe the line (218) with arrows that indicate the direction of the fluid, which is directed to the pressure control valve (221), first passing through the check valve (219), it is also observed that from the valve (221) the lines (222) and (223) are derived and these are connected with the 2-way valves, (224) and (226) respectively, where one can see that the spool (227) unblocks the feeding port that connects with the line (222), meanwhile the spool (225) of the valve (224) blocks the feeding port that connects with the line (223) and unblocks the main outlet orifice of the piston (228) that connects with the line (231). The fluid provided by the piston (213) and pressurized by the pressure control valve (221) is conducted by the line (222) to the interior of the piston (228) on the right side of the latter, whereby the plunger (229) will travel towards the left side of the piston (228) also displacing the fluid located on the left side of the piston (228), the displaced fluid is conducted by the line (231) to the check valve (232) which allows it to pass but it does not allow it to return, the line (231) continues to lead the fluid to the connector (257) that joins lines (231) and (230), note that in line (230) the check valve (233) is located, which prevents the fluid conducted by the line (231) from interacting with the line (230) in this way the fluid conducted by the line (231) is applied directly to the manifold (234), where the pressure lines are connected to do the work and the typical functions of the machinery to be applied such as a backhoe, steamroller, etc., where when the pressure and volume are not occupied and the main diesel motor is running, pressure and volume are released by relief valve (260). Once this function is carried out, the fluid is conducted through the line (251) to the cooling unit (252) which will return the fluid to the reservoir (203) at a temperature between 40° C. and 60° C. degrees Celsius, to be used again in a new cycle. As it can be seen, the general functioning of the second embodiment of the hydraulic pressure intensifier system (200) of this invention is the same as that of the preferred embodiment, only the hydraulic motor (134) has been changed for the manifold (234), so that said manifold is connected to the pressure lines to do the work and the typical functions of the machinery to be applied.

On the other hand, in the previous description the way in which the two pressure generators, the first generator (100a) and the second generator (100b). work configured in series has been presented, and how the first feeds the second; in this sense, in accordance with this invention, it will be evident to experts in the field that it is possible to attach more generators as required, where for example a third generator, it would be connected and powered by the second, and if a fourth were attached, it would be connected and powered by the third, where each of them will have an electrovalve electrically controlled by the PLC unit to make the directional changes of its corresponding plunger, with their respective lines fed with pressurized fluid from the pressure accumulator (140) and a pressure controlling valve, except for the last pressure generator. That is, if the series configuration is of four pressure generators, only the first, second and third will have pressure control valves. And the fourth, or last, will be connected to the hydraulic motor (134). The same happens when “N” generators are added, where only the last generator would not have a pressure control valve, since it would be directly connected to the hydraulic motor (134) or manifold (234). In accordance with the above, this is of utmost relevance, since it allows reducing the dimensions of the system through the use of pistons of smaller sizes and capacities, in which the pressures generated by them and their pressure control valves would be added to achieve desired final pressure.

Now, as in the first embodiment, when the plungers travel from one end to the other in their respective pistons, these, when reaching their limit, stop displacing fluid during the time that the directional changes system takes in making it, resulting in a small power drop in the system, to avoid this drop, modifications have been made to the plungers (see FIG. 3), these consist of making several bores (114c) in the first face (114a) and in the second face (114b) of the plunger in charge of performing the following functions: on the one hand, receiving the pressurized fluid that displaces the plungers, and on the other, the face that pushes the fluid during its travels, the depth (114d) of the bores (I 14c) on both faces (114a) and (114b) must be more or less equal, preventing them from communicating, and a wall (114e) of sufficient material must be left to withstand high stresses. As the plungers travel from one end to the other in their respective pistons, in the bores (114c) of the face that pushes the fluid, it accumulates and pressurizes for two reasons, first, due to the thrust that the plunger receives when the fluid is deposited inside the piston on the opposite side and begins to move the plunger, and the second, due to the opposition that the pressure control valve prevents the fluid from passing freely through it, the fluid passes until the pressure calibration mechanism is overcome by the force that the plunger exerts on the fluid at the moment it begins to move, this being the moment in which, between the plunger and the pressure control valve, pressure is created in the fluid, and in the corresponding line. This pressure and a part of the displaced fluid is stored in the bores in the face of the plunger that displaces the fluid, when the plunger reaches its limit and stops displacing fluid for an instant, the time it takes for the directional changes system to make the change of direction of the plunger, the volume pressurized inside the bores is discharged at the same moment avoiding a volume and pressure drop in the system that would manifest itself in a momentary loss of power. In accordance with the second embodiment of this invention, in said second embodiment no drag couplings are used as in the first embodiment.

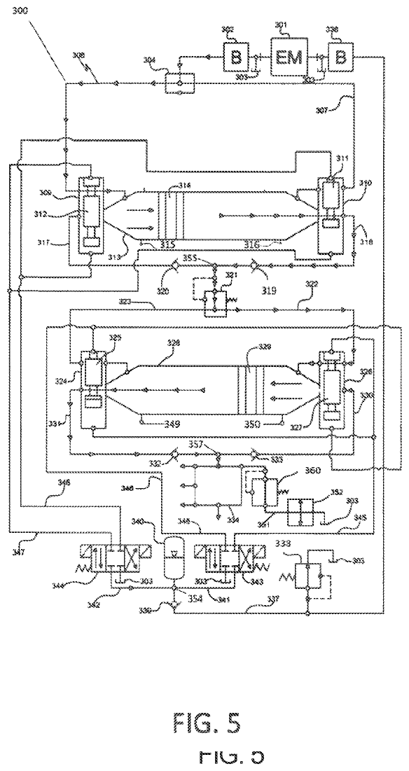

With reference now to FIG. 5, the third embodiment of the hydraulic pressure intensifier system (300) is shown, which is similar to the second embodiment (200), where the only difference is the use of an electrical motor (301) instead of a diesel motor, since in this embodiment the manifold (334) is connected to the pressure lines to do the work and the typical functions of plastic injection machines, high capacity hydraulic presses, hydraulic breakers, hydraulic elevators, cold rolling machines.

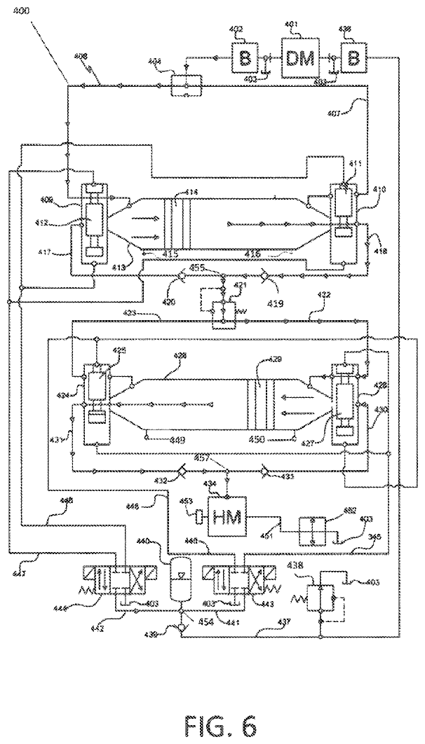

Now with reference to FIG. 6, the fourth embodiment of the hydraulic pressure intensifier system (400) is shown, which is similar to the preferred embodiment (100), where the only difference is the use of a diesel motor (401) instead of an electrical motor, since in this embodiment the hydraulic motor (434) has the function of transforming hydraulic energy into angular mechanical energy to do the work and the typical functions of buses, tractors, trains, ships, airplanes, cargo trucks, automobiles, agricultural tractors (harvesters, threshing machines, choppers etc., which include high volume liquid displacement pumps.

Since various aspects of various embodiments of this invention have been described, it should be noted that various alterations, modifications, and improvements can be made by experts in the field. Such alterations, modifications, and improvements are intended to be part of this description and are intended to be within the spirit and scope of the invention. Accordingly, the foregoing description and drawings are by way of example only.

1. A hydraulic pressure intensifier system, characterized in that it comprises: a main actuation subsystem; and directional change subsystem: wherein said main actuation subsystem comprises an angular-power-generating main motor, a pump connected to said motor and to a fluid reservoir, which sucks said fluid and fluidly displaces it; a means for generating and increasing pressure to provide fluid at a first pressure comprising; a first piston which inside it has: a plunger that moves linearly from an initial position to a final position and a travel limit sensor at each end of said piston; a 2-way valve at each outer end of said piston, which restricts or allows the passage of fluid to the interior or exterior thereof; a pressure control valve, fluidly connected to said 2-way valves, which has the function of accumulating and increasing said first pressure to a predetermined parameter to obtain a second pressure; a second piston fluidly connected to the pressure control valve, to receive the fluid with said second pressure, said second piston comprises inside: a plunger that moves linearly from an initial position to a final position and a travel limit sensor at each end of said piston; a 2-way valve at each outer end of said second piston, which restricts or allows the passage of fluid to the interior or exterior thereof, wherein said second piston increases the second pressure of the fluid to obtain a third pressure twice as high than the first pressure; a hydraulic motor, fluidly connected to said 2-way valves, which receives the fluid with the third pressure for its later use in other systems which require some work; a fluid cooling means, which cools the fluid coming from the hydraulic motor to send it to the fluid reservoir, and wherein said directional change subsystem comprises an angular-power-generating secondary motor, a second pump connected to said secondary motor and to said fluid reservoir, which sucks said fluid and fluidly displaces it; a pressure accumulator that receives the fluid displaced by the pump and that has the function of increasing the pressure in said fluid; a pair of electrovalves fluidly connected to said pressure accumulator to receive and direct the fluid with increased pressure towards the first and second pistons to return the plungers to their initial position to start a new work cycle, wherein said directional change subsystem operates parallel to and independently from said main actuation subsystems to end a complete cycle and repeat it indefinitely while the system is in operation.

2. The hydraulic pressure intensifier system according to claim 1, further characterized in that the power-generating motor is an electrical motor.

3. The hydraulic pressure intensifier system according to claim 1, further characterized in that the power-generating motor is a diesel motor.

4. The hydraulic pressure intensifier system according to claim 1, further characterized in that the plungers travel contrary to each other respectively.

5. The hydraulic pressure intensifier system according to claim 1, further characterized in that the plungers run parallelly in the same direction.

6. The hydraulic pressure intensifier system according to claim 1, further characterized in that it additionally comprises a drag coupling subject to the shaft of the hydraulic motor, which has the function of dragging only in one direction, depending on the direction of rotation that the system delivers, either clockwise or counterclockwise, in order to protect the entire system in case of E-stops.

7. The hydraulic pressure intensifier system according to claim 1, further characterized in that said plungers comprise a plurality of bores on both faces to prevent pressure drops within the system.

8. The hydraulic pressure intensifier system according to claim 7, further characterized in that the depth of said bores must be more or less equal on each face, preventing them from communicating with each other, leaving a wall between them with a sufficient thickness so that it withstands high stresses.

9. The hydraulic pressure intensifier system according to claim 1, further characterized in that it is possible to add “N” generators as required, where only the last generator would not have a pressure control valve, since it would be directly connected to the hydraulic motor.

10. The hydraulic pressure intensifier system according to claim 9, further characterized in that adding more generators makes it possible to reduce the dimensions of the system by using pistons of smaller sizes and capacities, in which the pressures generated by them and their pressure control valves would be added to achieve desired final pressure.

11. A hydraulic pressure intensifier system, characterized in that it comprises: a main actuation subsystem; and a directional change subsystem; wherein said main actuation subsystem comprises an angular-power-generating main motor, a pump connected to said motor and to a fluid reservoir, which sucks said fluid and fluidly displaces it; a means for generating and increasing pressure to provide fluid at a first pressure which comprises, a first piston which inside it has: a plunger that moves linearly from an initial position to a final position and a travel limit sensor at each end of said piston; a 2-way valve at each outer end of said piston, which restricts or allows the passage of fluid to the interior or exterior thereof; a pressure control valve, fluidly connected to said 2-way valves, which has the function of increasing said first pressure to a predetermined parameter to obtain a second pressure; a second piston fluidly connected to the pressure control valve, to receive the fluid with said second pressure, said second piston comprises inside: a plunger that moves linearly from an initial position to a final position and a travel limit sensor at each end of said piston; a 2-way valve at each outer end of said second piston, which restricts or allows the passage of fluid to the interior or exterior thereof, wherein said second piston increases the second pressure of the fluid to obtain a third pressure twice as high than the first pressure; a manifold which receives the fluid with the third pressure and to which the pressure lines are connected to do the work and the typical functions of the machinery to be applied: a fluid cooling means, which cools the fluid coming from the manifold to send it to the fluid reservoir; and wherein said directional change subsystem comprises a second pump connected to said main motor and to said fluid reservoir, which sucks said fluid and fluidly displaces it; a pressure accumulator that receives the fluid displaced by the pump and that has the function of increasing the pressure in said fluid; a pair of electrovalves fluidly connected to said pressure accumulator to receive and direct the fluid with increased pressure towards the first and second pistons to return the plungers to their initial position to start a new work cycle, wherein said directional change subsystem operates parallel to and independently from said main actuation subsystems to end a complete cycle and repeat it indefinitely while the system is in operation.

12. The hydraulic pressure intensifier system according to claim 11, further characterized in that the power-generating motor is an electrical motor.

13. The hydraulic pressure intensifier system according to claim 11, further characterized in that the power-generating motor is a diesel motor.

14. The hydraulic pressure intensifier system according to claim 11, further characterized in that plungers travel contrary to each other respectively.

15. The hydraulic pressure intensifier system according to claim 11, further characterized in that the plungers run parallelly in the same direction.

16. The hydraulic pressure intensifier system according to claim 11, further characterized in that said plungers comprise a plurality of bores on both faces to prevent pressure drops within the system.

17. The hydraulic pressure intensifier system according to claim 16, further characterized in that the depth of said bores must be more or less equal on each face, preventing them from communicating with each other, leaving a wall between them with a sufficient thickness so that it withstands high stresses.

18. The hydraulic pressure intensifier system according to claim 11, further characterized in that it is possible to add “N” generators as required, where only the last generator would not have a pressure control valve, since it would be directly connected to the hydraulic motor.

19. The hydraulic pressure intensifier system according to claim 18, further characterized in that adding more generators makes it possible to reduce the dimensions of the system by using pistons of smaller sizes and capacities, in which the pressures generated by them and their pressure control valves would be added to achieve desired final pressure.
